(19) United States
(12) Patent Application Publication
(10) Pub. No.: US 2003/0093394 A1
(43) Pub. Date: May 15, 2003

(54) Knowledge capture and retrieval method

(76) Inventor: Normand Frenette, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/292,707

(22) Filed: Nov. 12, 2002

Related U.S. Application Data
(60) Provisional application No. 60/332,951, filed on Nov. 14, 2001.

(51) Int. Cl. G06N 5/00; G06F 17/00

(52) U.S. Cl. 706/45

(57) ABSTRACT

A system and method for capturing and retrieving domain-specific information is specified in which knowledge elements are used to capture small pieces of expert information. Knowledge elements can be linked with each other by knowledge carrying links which represent expert content. Knowledge elements and their associated knowledge-carrying links are stored in a knowledge map, and the knowledge process is captured in cases.

### RELATED APPLICATIONS

This application is related to provisional patent application Serial No. 60/332,951, filed on Nov. 14, 2001.

### BACKGROUND OF THE INVENTION

In tackling the problem of documenting, re-using and sharing domain specific knowledge, a number of solutions are currently well known in the prior art and in use today. Expert systems and rule-base reasoning, such as disclosed in U.S. Pat. No. 6,035,292 (Matsushita et al.) are probably the most focused and powerful methods, however they require a heavy investment in time from both domain experts, computer programmers and expert system engineers.

Case-based reasoning, such as is disclosed in U.S. Pat. No. 5,797,135 (Whalen et al.) attempts to classify examples of the domain knowledge in cases. This method is often combined with some of rule-base technology, such as is disclosed in U.S. Pat. No. 5,581,614 (Allen et al.) and U.S. Pat. No. 5,224,206 (Simoudis), to yield a simple knowledge extraction process, befitting untrained users in the domain knowledge. The complexity of these solutions require the intervention of so-called knowledge engineers to convert written knowledge into the information structure and rules prescribed by the case-based reasoning system, which is an added cost that can usually only be borne by organizations that serves a large number of untrained users (such as an e-commerce storefront for example).

In fact, the scope of knowledge sharing is often limited within the boundary of organizations where a certain level of domain knowledge exists for all individuals within the organization. These organizations face a transfer of knowledge problem between experts and the rest of the organization. To reduce implementation cost linked with overhead knowledge workers, complex artificial intelligence-base techniques are shunned in favor of solutions that rely on the basic domain knowledge possessed by all users to help with the discrimination and validation of the knowledge as it applies to a particular situation. One such solution is to use search and cataloguing technology, which, fueled by the Internet, has lately been used to retrieve and share knowledge documents written by experts, such as is disclosed in U.S. Pat. No. 5,940,821 (Wical).

These methods work best when the knowledge base of documents is large and diversified. Such systems are not very discriminating when searching a narrow field of technical expertise, because the words used for the search are often found in many documents. Furthermore, the result is a list of potentially matching documents that must be read and analyzed to determine their relevancy to the issue at hand. This gives rise to the final problem: The experts who are expected to generate these documents are not necessarily trained in technical writing and vulgarization. Thus, the resulting search often identifies documents which are incomprehensible to the average user, thereby reducing the “sharing capacity” of the information.

Currently, one must either invest in overhead for expert system or knowledge engineers to organize information, or be satisfied with search tools that yield documents that cannot easily be shared.

### SUMMARY OF THE INVENTION

Therefore, if would be desirable to provide a means to capture and organize knowledge information that allows experts to do it themselves without impacting unduly their daily work and responsibilities and without recourse to external knowledge engineers. It would also be desirable to provide a means whereby information is yielded that is automatically structured in a way that can be easily retrieved and understood by people with a minimum understanding of the field but who are otherwise non-experts.

This invention therefore provides a knowledge capture and retrieval system that allows experts to capture information about knowledge-based processes and automatically structures the information in a manner that allows retrieval by non-experts with a minimum of technological background in the field. This invention is particularly notable in that its software implementation utilizing relational database technology allows the knowledge owner to easily capture and record knowledge information following the normal processes in their day-to-day work, without having to specify any other parameters used to classify or access the knowledge, such as is required in the prior art.

The system and method disclosed herein organizes specific instances of the knowledge processes into cases, thus is part of a broad field of knowledge management usually referred to as case-based reasoning. Searching through such systems usually involves reading through a succession of cases that partly match the current situation experienced by a non-expert. The invention provides a more effective alternative to this approach by using the knowledge capture methodology to automatically generate check lists for non-expert users, thereby allowing them to find the case most applicable to their situation.

Because the invention focuses on the underlying knowledge processes rather than the specific technical domain knowledge itself, it can easily be applied to a very broad cross-section of knowledge-intensive domains, as varied as technology, medicine, law and sales, to name a few.

### DESCRIPTION OF THE DRAWINGS

FIG. 1 shows a knowledge map

FIG. 2 shows a database schema used to capture a knowledge map.

FIG. 3 shows the database schema for knowledge-carrying links.

FIG. 4 shows the data structure of a knowledge element.

FIG. 5 shown one embodiment of a checklist.

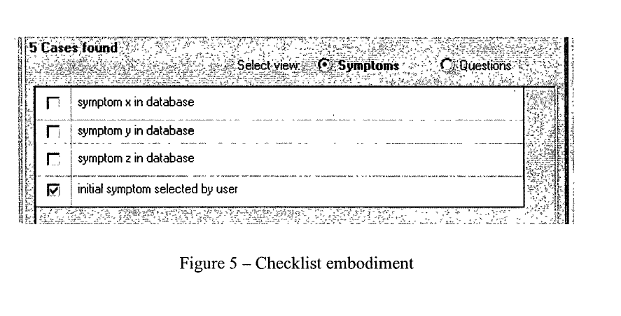

FIG. 6 is a flow chart for the recording of knowledge elements in a case.

FIG. 7 shows details of portions of the flow chart of FIG. 6.

FIG. 8 is a flow chart for the retrieval of an existing case in the database.

### DESCRIPTION OF THE INVENTION

The invention addresses the problem of recording, retrieving and sharing knowledge about processes that require expert knowledge to be concluded satisfactorily. An example of such a process is the so-called “problem-solving” process, used herein when specific examples of the invention are required for illustration purposes. The invention, however, is not limited to the problem-solving process, but may be used to store and retrieve knowledge related to other types of processes.

The invention defines a knowledge map that embodies the knowledge process normally used by experts in this process. The knowledge map is not related to the topic or domain where the process is applied. For example the “problem-solving” process used by experts in many technical domains is not domain-specific. Only the information that will be stored in the various elements of the knowledge map is domain-specific. Hence the invention can be applied to multiple technical domains without changing the structure of the knowledge map. A particular instance of an application of the knowledge process is called a “case.” In the problem solving example, a case corresponds to a particular problem and its solution. Knowledge maps are comprised of three separate entities: knowledge elements (KE), knowledge-carrying links (KCL), and knowledge element equivalences (KEE).

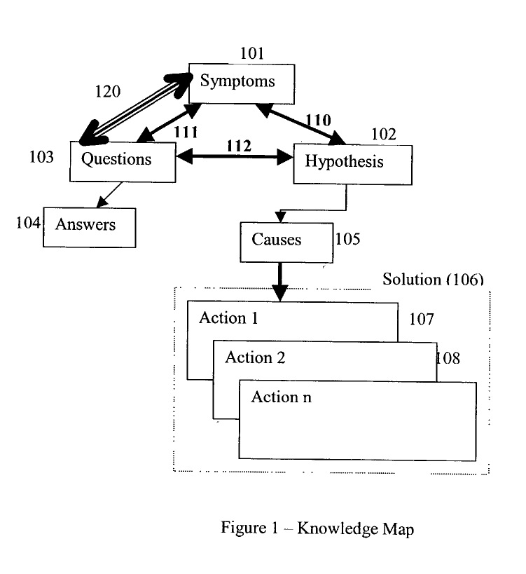

Knowledge elements, linked to each other in a particular manner, represent the separate steps of the knowledge process. Information about the physical observations made through the knowledge process is stored within the knowledge elements. In the problem-solving process shown in FIG. 1, each box represents a different knowledge element. Symptoms (box 101) are used to describe the problematic behavior. Experts then either formulate an hypothesis (box 102) about the possible cause of the problem and/or questions (box 103) and record their results (box 104). These results can either confirm or infirm the hypothesis, or help to uncover further symptoms. This process is repeated in any possible sequence until ultimately a hypothesis is confirmed and a cause (box 105) is found. The expert then implements a series of actions (box 109-110) that form the solution to the problem (box 108). To record a particular case, the system of the invention need only record the information for each knowledge element, in sequence.

Certain knowledge map connections between knowledge elements carry inductive or deductive knowledge. For example, knowing what question to ask after a symptom is observed requires the experience of an expert. Thus the invention defines a knowledge-carrying link between a particular question and a particular answer. The problem solving example of FIG. 1, defines four such links: symptom→question (link 111), symptom→hypothesis (link 110), question→hypothesis (link 112), and, cause→action (link 1113). The invention records separately the existence of knowledge-carrying links between particular pairs of knowledge elements (for example: a specific question follows a specific symptom) separately from the cases themselves. This allows separate retrieval of the experience-based knowledge of the experts.

The knowledge map also defines which pair of knowledge elements may carry equivalence status. Equivalent knowledge elements are knowledge elements that are potentially interchangeable in the application of the knowledge process. In the problem-solving example, there is one such equivalence as shown in FIG. 1, indicated by equivalence link 120 between questions and symptoms. It is possible to express a symptom as a question and its specific answer or vice-versa. This implies that a problem has been described either in terms of a symptom or its equivalent question and answer, depending on how the expert has approached the problem. The invention implements a process for converting a knowledge element type into an equivalent other type and for storing equivalences in corresponding knowledge element table ensuring that cases containing either version of the knowledge are deemed equivalent for search purposes.

Implementation of the Knowledge Map

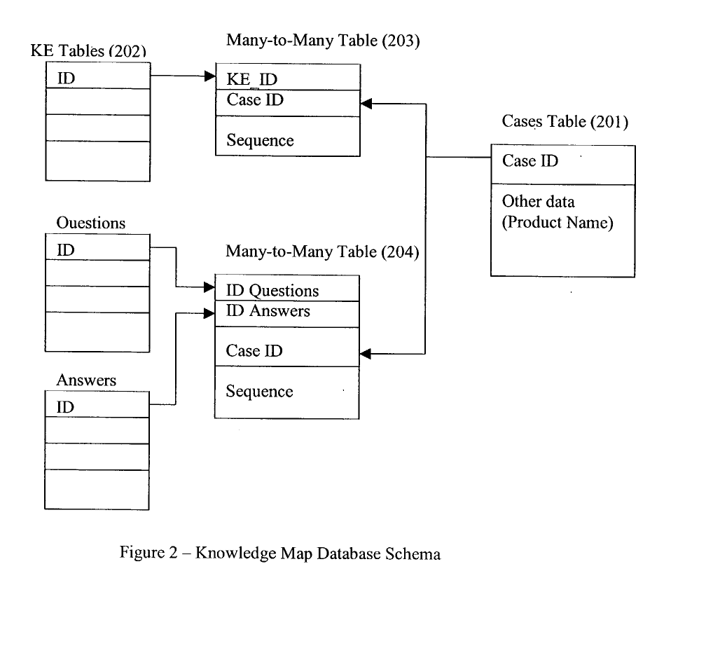

The invention records technical information in a relational database. The knowledge map represents the structure or schema of the database as shown in FIG. 2. Each knowledge element is given a separate table (box 202) of the database. Within a table, a unique identifier KEx_ID is assigned to each new instance of the knowledge element representing a row of the table. Box 201 represents the case table where each rows contains as a minimum a CASE_ID as unique identifier, and any other specific case data. In the problem-solving example, the product name to which the problem applies is added to the case data. Each case is made up of a particular set of different knowledge elements describing the particular “path” through the knowledge process as recorded by the expert. Box 203 represents a so-called many-to-many table to link the particular knowledge elements of a given knowledge element table to a particular case of the case table (box 203). When knowledge elements must occur together in a case, for example “questions” and “results” in problem solving, each ID of each knowledge element type is given one column of the many-to-many table box 204. In our example, this allows the same question to be used in different cases with two different answers.

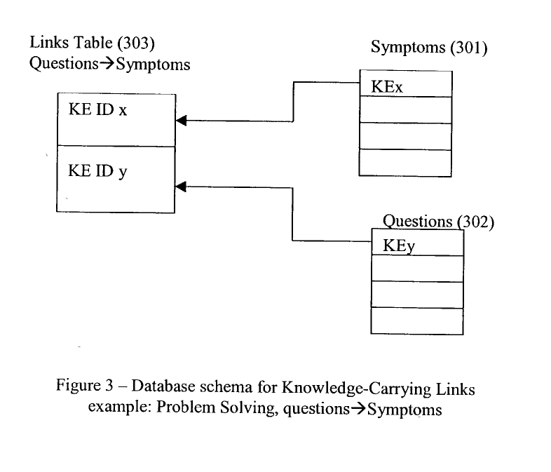

The preferred embodiment for the knowledge-carrying links defines a separate link table as shown in FIG. 3. When an expert has asked and recorded a specific question immediately after having recorded a specific symptom in the case, the identifier KEx of the symptom (box 301) and KEy of the question (box 302) are both entered on a single row of the link table (box 303). And alternative embodiment of the knowledge-carrying links foregoes the creation of specific tables to hold the link by constructing appropriate queries on the case table and related many-to many table to identify which knowledge elements of type Y follow the knowledge element of type X, yielded a similar result as the linked tables.

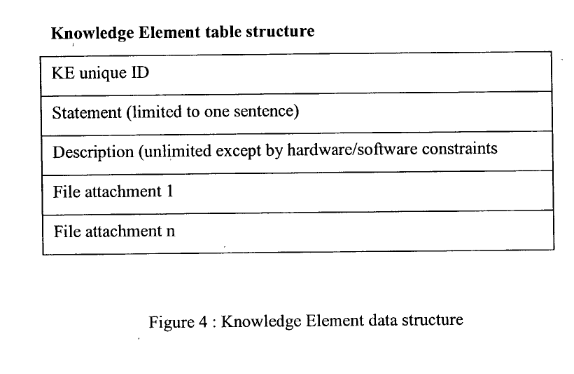

The invention solves the difficulty of understanding a complex case written by an expert by structuring the knowledge as it is being recorded. This is effectively implemented through a standard knowledge element data structure (FIG. 4), which yields concise and clear descriptive writing. The domain knowledge is stored in two separate text fields: a “statement” (box 401) of limited length (approximately one sentence long) and a “detailed description” (box 402) field of potentially infinite size, limited only by the physical parameters of the storage medium and/or the database used. Finally a means of recording multiple links (box 403) to external documents can also be added to further define a specific knowledge element

Software Embodiment of the Invention

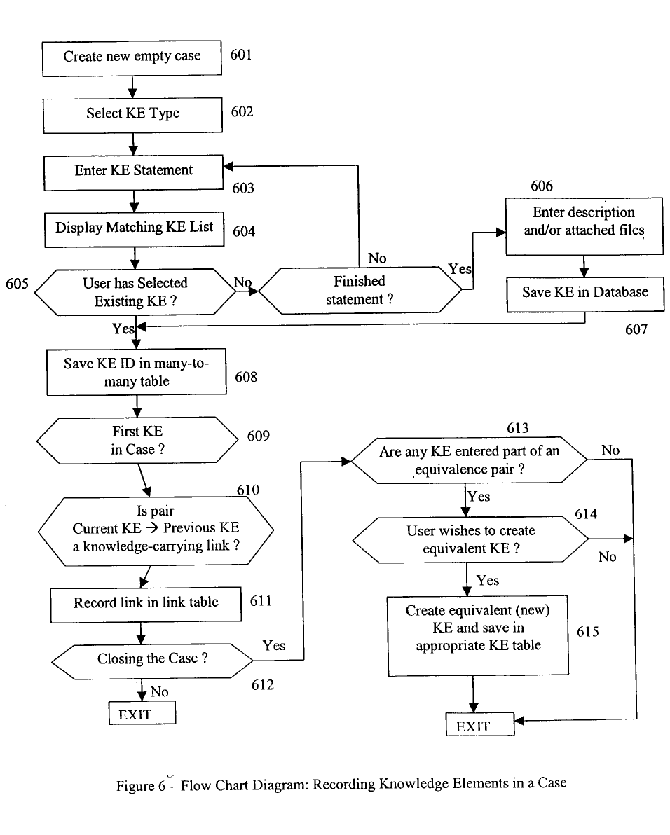

FIG. 6 shows a flow chart diagram of how case information is recorded by experts. Such a diagram can be implemented through various software programming techniques available to those schooled in the art.

First an empty case is created in the database which assigns it a new case ID number (box 601). An appropriate user interface is provided that allows an expert to pick any one of the possible knowledge elements in the knowledge map. No attempt is made to force the experts to use a particular “ideal” sequence of knowledge elements implementing a specific path through the knowledge map. The expert selects a knowledge element and proceeds to enter a brief description in the statement field (box 602). As the expert enters information, a list of matching statements for that knowledge element type is displayed and continuously updated (using some form of text-based search and matching technique known to those schooled in the art). The expert can either select an existing knowledge element from the list (box 605), or create a new knowledge element to describe the physical situation being observed. The expert can also add further details in the description field as well as attach files (box 606) to the knowledge element before saving it to the case. If the knowledge element is new to the database, it is first recorded in the corresponding knowledge element table (box 607). Then the corresponding many-to-many table is used to add this knowledge element to the current case (box 608). The sequence in which the knowledge element was added to the case is recorded as well.

If the knowledge element being saved to the case is not the first knowledge element on the case (box 609), the software will determine if the sequence “current knowledge element”→“previous knowledge element” represents a “knowledge-carrying link” as defined in the knowledge map (610). If so, the corresponding knowledge-carrying link table will be updated automatically (611). This is done without any interaction with the expert other than the simple recording of sequential knowledge elements through the user interface.

If the expert has completed the case, the case can be closed (box 612). If any of the knowledge elements created in the case are part of an equivalence pair (box 613) the user is given the opportunity to edit the wording of the knowledge element to create the equivalent knowledge element (box 614). The edited knowledge element is then created in the appropriate knowledge element table (box 615) and its equivalency fields points to the original knowledge element are updated accordingly (box 616).

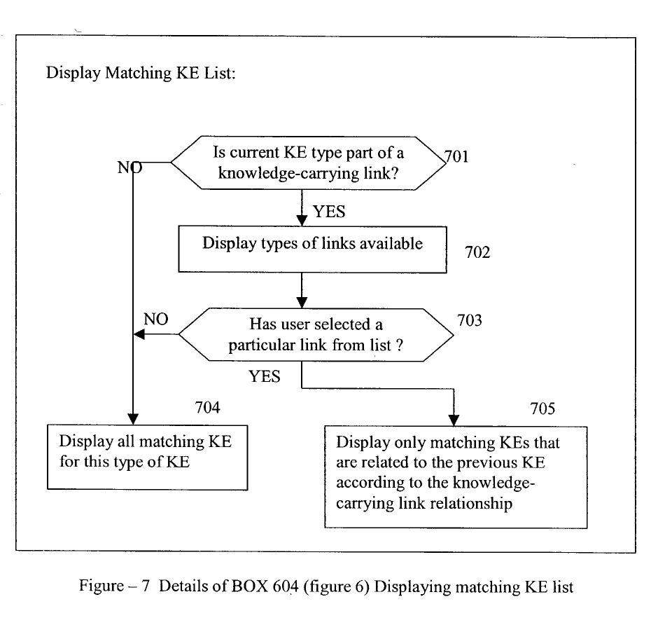

The existence of knowledge-carrying links allows technical personnel to query the database to get ideas as to the next possible step to take in the knowledge process. For example, in the problem-solving example, a user may have entered a symptom and is looking for ideas about what questions (or test) can be asked to identify a cause. This is achieved by narrowing the field of search in box 604—displaying matching knowledge elements. FIG. 7, shows a flow chart diagram of the software process. When the current knowledge element (question) is part of a knowledge-carrying Link, the software displays the type of links available (box 702) for the user to select. For example selecting the Link: questions→symptoms would only display questions that were asked by other experts when the last symptom entered in the case was present. Thus upon selecting a link, the software displays the appropriate restricted list of knowledge elements (box 705). If no link is selected, all knowledge elements matching the statement typed by the user are displayed (box 704) regardless of the precious knowledge elements in the case.

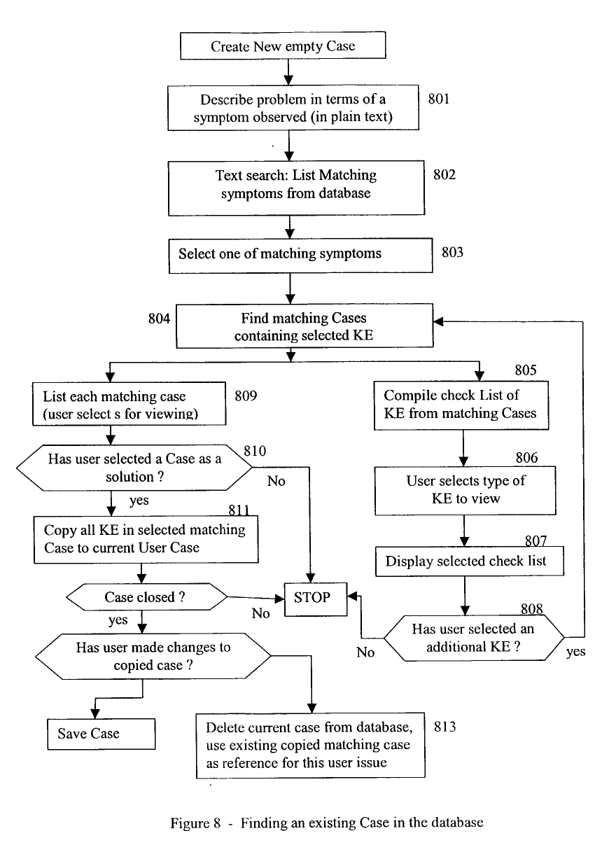

FIG. 8 shows a flow chart diagram describing how a non-expert can find an existing case in the database. First a new case is created for the user (box 801). Through the appropriate user interface, the user is asked to input a description of one a the knowledge element which serves as a typical starting point in the knowledge process (box 802). The problem-solving process uses symptoms for this. A suitable text-search is performed in the database and a list of matching knowledge elements is presented to the user (box 803). The user makes a selection from the list of available statements (box 803). Upon selection, the database is search for all cases that contain at the user-selected knowledge element (box 804). A list of these cases can be displayed to the user and means to read each one are provided through the user interface (box 811). When too many matching cases exist, it becomes cumbersome to read all cases to find the correct one. The software creates automated check-lists by analyzing all matching cases and displaying all knowledge element of a given type that occur at least once in the list of matching cases (box 805). In the problem-solving examples such lists are created for symptoms and for questions/answers, and a means to display either list is provided. Each lists is presented in a manner similar to FIG. 9, where a means of selecting additional knowledge elements is provided (in this case a “check-box”). Thus the user can read the list and select any of the knowledge-element presented match the current problem (box 808). The software then narrows the list of matching cases further by eliminating any cases that do not contain both the original knowledge element selected by the user and this new selection (box 804). The process is repeated until the list of matching cases is narrowed to manageable few, where the user can decide which case fits the current problem. A means of selecting a particular case can be provided as part of the user interface (box 810). If the particular embodiment of the invention is meant to record what cases users have selected, the software copies all knowledge elements of the selected matching case to the current case (box 811). If the user makes no further changes to the case, upon closing the case, the software deletes the current case from the database and the user's issue now points to the selected case (box 812)

I claim:

1. A method for building a knowledge map comprising the steps of:
creating a case;
adding one or more knowledge elements to said case; and
adding links in said knowledge map between certain of said knowledge elements added to said case.

2. The method of claim 1 wherein said step of creating a case further comprises the steps of:
creating a new knowledge element;
searching said knowledge map for matching or similar knowledge elements to said newly-created knowledge element; and
selecting one of said matching or similar knowledge elements and adding it to said case or, if no matching or similar knowledge elements are found, adding said newly created knowledge element to said case.

3. The method of claim 2 wherein said searching step further comprises the step of performing a text search on said existing knowledge elements using textual information in said newly-created knowledge element.

4. The method of claim 1 wherein said step of adding one or more knowledge elements to said case further comprises the steps of:
displaying, each time a knowledge element is added to said case, a list of other knowledge elements which are linked to said newly-added knowledge element; and
adding one of said listed knowledge elements to said case or creating a new knowledge element and adding it to said case.

5. The method of claim 4 wherein said list of linked knowledge elements is limited to knowledge elements of certain, specified types.

6. The method of claim 1 wherein said knowledge elements are typed and wherein the step of adding links further comprises the step of adding a link between a first knowledge element of a first type and a second knowledge element of a second type if said second knowledge element follows said first knowledge element in said case.

7. The method of claim 6 wherein said links are explicitly stored in a database, with reference to the knowledge elements which are being linked.

8. The method of claim 6 wherein said links are implicitly stored by virtue of the relative positions of knowledge elements within each of said cases.

9. The method of claim 1 wherein said knowledge elements are comprised of a short text field and a long text field, and may optionally have one or more files associated therewith.

10. The method of claim 1 wherein said links in said knowledge map between certain of said knowledge elements are established according to a set of pre-established rules.

11. The method of claim 1 wherein some types of knowledge elements or some combination of types of knowledge elements can be equivalent to knowledge elements of as different type.

12. The method of claim 1 wherein said knowledge map can be use to implement a problem-solving process.

13. A method of retrieving knowledge from a knowledge map comprising the steps of:
creating a current case;
specifying an initial knowledge element and associating said initial knowledge element with said current case;
performing a search of said knowledge map for knowledge elements which match or are similar to said initial knowledge element, and displaying all cases associated with one or more of said matching or similar knowledge elements;
displaying all knowledge elements associated with said displayed cases;
selecting one or more of said displayed knowledge elements; and
modifying said list of displayed cases to display only cases containing all of said selected knowledge elements.

14. The method of claim 13 wherein said step of performing a search of said knowledge map for knowledge elements which match or are similar to said initial knowledge element, and displaying all cases associated with one or more of said matching or similar knowledge elements further comprises the step of:
selecting one or more of said matching or similar knowledge elements; and
displaying only those cases associated with said selected knowledge elements.

15. The method of claim 13 wherein said search of said knowledge map for knowledge elements which match or are similar to said initial knowledge element is a text-based search.

16. The method of claim 13 wherein said step of displaying all knowledge elements associated with said displayed cases and selecting one or more of said displayed knowledge elements further comprises the steps of:
displaying said knowledge elements in a checklist; and
selecting one or more of said knowledge elements by checking a box in said checklist.

17. The method of claim 13 further comprising the steps of:
selecting one of said displayed cases;
copying all knowledge elements associated with said selected case to the current case;
modifying one or more of said copied knowledge elements; and
saving said current case.

18. The method of claim 16 wherein said knowledge elements are typed and further wherein said step of searching for similar or matching knowledge elements can be limited to certain types of knowledge elements.

19. The method of claim 17 wherein said method can be used to implement a problem-solving process.

20. A system for storing knowledge in a knowledge map comprising:
software for creating a set of knowledge elements;
software for specifying an initial knowledge element;
software for searching said knowledge map for matching or similar knowledge elements and displaying a list containing the results of said search;
software for allowing the selection of one or more knowledge elements from said list to be added to said set of knowledge elements or for adding said initial knowledge element to said set of knowledge elements; and
software for determining if knowledge elements in said set of knowledge elements should be linked to other of said knowledge elements in said set of knowledge elements, and for establishing said links.

21. The system of claim 20 further comprising:
software for adding additional knowledge elements to said set of knowledge elements, said additional knowledge elements being newly-created knowledge elements or knowledge elements selected from a list of knowledge elements linked to knowledge elements already part of said set of knowledge elements.

22. The system of claim 20 wherein said knowledge elements are typed and further wherein said software for determining if knowledge elements should be linked establishes a link between a first knowledge element and a second knowledge element based on the type of said first and said second knowledge elements and their relative position within said set of knowledge elements.

23. A system for retrieving knowledge from a knowledge map comprising:
software for creating a current set of knowledge elements;
software for specifying an initial knowledge element and associating it with said current set;
software for searching said knowledge map for knowledge elements which match or are similar to said initial knowledge element and for displaying a list of all sets associated with one or more of said matching or similar knowledge elements;
software for displaying all knowledge elements associated with said listed sets;
software for allowing the selection one or more of said displayed knowledge elements; and
software for modifying said list of sets to display only sets containing all of said selected knowledge elements.

24. The system of claim 23 wherein said software for searching said knowledge map for knowledge elements which match or are similar to said initial knowledge element and for displaying a list of all sets associated with one or more of said matching or similar knowledge elements allows the selection of one or more of said matching or similar knowledge elements; and displays only those sets associated with said selected knowledge elements.

25. The system of claim 23 wherein said software for searching said knowledge map for knowledge elements which match or are similar to said initial knowledge element utilizes a text-based search to find said matching or similar knowledge elements.

26. The system of claim 23 wherein said software for displaying all knowledge elements associated with said displayed sets and for allowing the selection one or more of said displayed knowledge elements further displays said knowledge elements in a checklist and allows selection of knowledge elements from said checklist by checking a box in said checklist associated with a particular displayed knowledge element.

27. The system of claim 23 further comprising:
software for allowing the selection one of said displayed sets;
software for copying all knowledge elements from said selected set to said current set; and
software for modifying said current set and saving said current set as a new set.
